(19) United States
(12) Patent Application Publication
(10) Pub. No.: US 2001/0045029 A1
(43) Pub. Date: Nov. 29, 2001

(54) Wheelbarrow mounted snowplow

(76) Inventor: Richard Eustis Fulton, Grand Junction, CO (US)

Correspondence Address: Richard E. Fulton, 1556 Wellington Ave., GRAND JUNCTION, CO, 81501, US

(21) Appl. No.: 09/788,187

(22) Filed: Feb. 15, 2001

Related U.S. Application Data
(60) Provisional application No. 60/182,758, filed on Feb. 16, 2000.

(51) Int. Cl. E01H 5/06; B62B 1/04

(52) U.S. Cl. 37/266; 37/270; 37/285; 280/47.18; 280/47.26; 37/265

(57) ABSTRACT

This invention is in the field of snow removal. More particularly, the invention provides a snowplow blade and an attachment apparatus to be secured to the front of a contractors type wheelbarrow and operated manually. Snow removal is facilitated by the ability to add ballast to the wheelbarrow, which preserves momentum, and by the unique design.

### CROSS REFERENCE TO RELATED APPLICATION

The present invention is a continuation in part of provisional patent application Ser. No. 60/182758, filed on and claiming priority of Feb. 16, 2000, the full disclosure of which is incorporated herein by reference.

### BACKGROUND

1. Field of Invention

This invention is in the field of snow removal. More particularly, the invention provides a snowplow blade and an attachment apparatus to be secured to the front of a contractors type wheelbarrow and operated manually. Snow removal is facilitated by the ability to add ballast to the wheelbarrow, which preserves momentum, and by the unique design.

2. Description of Prior Art

Over one half of the United States receives repetitive snowfall that must be cleared from sidewalks, driveways, patios, and other areas. Clearing or sanding streets and roads is the responsibility of local municipal and county governments, which respond in a variety of ways. Homeowners and small business owners must clear driveways, sidewalks, and parking areas. Homeowners must rely on expensive professional services who may not respond on a timely basis, manual snow shovels which are time consuming and labor intensive, and motorized snow blowers which are expensive, typically cut no more than a 20 inch swath, and are ineffective in heavy or wet snows. They are also time inefficient, and frequently are problematic to start and to maintain.

The present invention offers the homeowner and small business owner an inexpensive and affordable means of manual snow removal that is much more time efficient and much less physically demanding than any prior art device. The present invention is a unique snowplow that is secured to the front of a wheelbarrow, an implement which is commonplace and owned already by millions of homeowners.

Prior art snow shovel type devices include U.S. Pat. Nos. 5,440,828, 4,264,095, 4,597,204, 6,053,548, and 4,245,411. Prior art wheeled snow removal devices include U.S. Pat. Nos. 4,910,893, 5,511,327, 5,048,206, 5,493,797, 5,669,163, and 5,581,915. Prior art roof snow removal devices include U.S. Pat. Nos. 3,583,747 and 5,791,707. Prior art multipurpose implements include U.S. Pat. Nos. 3,977,477 and 4,090,457. In U.S. Pat. No. 4,570,961, Chateauneuf describes a multi-purpose transport cart in which the bucket of the barrow configuration may be used as a snow shovel, but only when it is removed from the truck or chassis. Chateauneuf teaches away from using a wheelbarrow design. None of the prior art devices utilize the unique properties of a wheelbarrow, i.e., leverage, maneuverability, capacity to add weight or mass, large wheel, and the fact that millions are available for use. Most of the prior art devices are push devices attached to a variety of show shovel handles, or, in the case of the wheeled devices, flimsy, lightweight, time inefficient, and offer little advantage over a standard snow shovel.

### OBJECTIVES AND ADVANTAGES

Accordingly, it is an object of the current invention to provide a means of manual snow removal that is economical, time efficient, and not physically demanding. The snowplow of the present invention truly offers the homeowner advantages over current methods of snow clearance from driveways, parking areas, sidewalks, patios, and decks. The present invention offers a preferable alternative to the current choice of snow shovels, which are demanding physically and time inefficient, snow blowers, which are expensive, difficult to maintain, and ineffective in heavy and wet snows, and commercial snow removal concerns. The snow pusher devices available are rather flimsy, time consuming, inefficient, and generally incapable of clearing large amounts of snow quickly and easily. Fallen snow can be heavy, especially when compacted with a pushing motion of some of these devices, when wet and laden with moisture, or after repeated freezings. The currently available snow pushers have great difficulty in efficiently clearing snow because they are rather lightweight and do not contain enough mass to overcome the weight of the snow. Unlike a vehicle-mounted snowplow, these devices tend to be lightweight so as to be handled easily by average person. This works to the disadvantage of the effectiveness of the snow pusher device and the operator. The weight of the snow overwhelms the efforts of the operator to push the current lightweight snow pushers so that momentum is not maintained and the forward progress of the device and the operator is stopped.

The law of “conservation of momentum” recognizes that the momentum of an object is a measure of the difficulty of arresting its motion. Both the mass and the velocity of an object enter into its momentum. Specifically, it is the product of the mass, m, and the velocity, v, which determines the degree of difficulty in stopping a moving body. This product, mv, is called the momentum and is designated by the letter p, and is expressed as:

momentum=p=mv

Therefore, an increase in mass, which is equivalent to weight, would proportionately increase momentum. A movement or object which has a great deal of momentum is one that tends to keep going and can be stopped only with difficulty. In the case of a manually operated snowplow or snow pusher, the greater the weight of the snow handling device, the greater the momentum, and, once motion is achieved, the easier it will be to keep it moving.

This concept can also be explained by the classic equation representing Newton's Second Law of Motion, F=MA, where F is force, M is mass, and A is acceleration. One can see that force, F, is directly proportional to mass, M. Simplistically, the more the mass (M) of the snow pusher or snowplow, the more force (F) exerted by the snow will be needed to accelerate (decelerate) the device to zero. Providing a device with enough mass (M) in a compact design so that significant force (F) can be exerted on the snow has yet to be accomplished.

Therefore, there is a need for a snow removal device for use by the average homeowner which is easy to handle, has enough mass to readily clear snow from walkways, patios, decks, and the like, is inexpensive and affordable, is easily stored, and can be operated by either sex of most any age.

The device of the current invention solves these problems very simply. It provides for a snowplow blade and an attachment apparatus that may be mounted to the front of a wheelbarrow. The blade may be adjusted at any one of several angles to the longitudinal axis of the wheelbarrow. The wheelbarrow, especially contractor's type wheelbarrows, may have enough mass to propel the wheelbarrow and blade through the snow easily and effectively. The wheelbarrow wheel serves as a leverage point to lower the blade onto the ground or surface. The leverage of the wheelbarrow permits the addition of significant mass to the wheelbarrow and/or the snowplow blade without significant additional effort by the operator. In the case of deep or heavy snows, ballast may be added to the wheelbarrow to give it more weight and mass (M) to overcome the inertia and weight of the snow being plowed. The ballast may consist of any readily available object such as snow, bricks, sand bags, spare tires, tools, or any of the contents found in a typical garage. The deeper and heavier the snow, the more ballast may be incrementally added to address the particular situation.

The wheelbarrow-mounted snowplow of the current invention may be mounted to other yard or garden devices frequently owned by the homeowner, as well. These would include lawn carts, tillers, hand trucks, lawn mowers, and most any manually operated, wheeled device designed for home or garden use.

In a preferred embodiment, the wheelbarrow mounted snowplow of the current invention would be comprised of a snow plow blade 24-48 inches in width, 8-18 inches in height, and a curvature with a radius of 10-20 inches. Mounting brackets attachable to the wheelbarrow (hereinafter, the “attachment apparatus”) or other garden device are provided. In the case of the wheelbarrow, the brackets may attach to the usual longitudinal members that support the bucket and extend as handles. They may however be fitted to the bucket or other members. A preferred embodiment provides an attachment apparatus that is releasably affixed to the front bracket that joins the two wooden arms that support the wheel attachment means and support the wheelbarrow bucket and extend rearward to form the handles. A hinge mechanism of the attachment apparatus placed at the upper level of this brace allows the blade to rotate to a ground contact position when plowing, but to rotate to a non-plowing position at other times. A second pivoting mechanism is also provided so that the blade can be angulated laterally to either side. This may be part of the attachment apparatus.

Therefore, this patent application contains means for the homeowner to easily clear the driveway and walkways of snow with little effort and expense by providing a snowplow blade attached to a wheelbarrow. It is an object of the invention that the homeowner may use an implement that he may already possess, in that it would preclude purchase of, and developing familiarity with, still yet another piece of lawn equipment. Still further objectives and advantages will become apparent from a consideration of the ensuing description and accompanying drawings.

### BRIEF DESCRIPTION OF THE DRAWINGS

FIG. 1 is a side view of a wheelbarrow with the current invention attached to the front brace of the wheelbarrow.

FIG. 2 is a side view of a wheelbarrow with the current invention attached to the front brace. The handles of the wheelbarrow are raised into an operating position, which lowers the blade of the snowplow onto the ground or surface to be plowed.

FIG. 3 is a side view of a wheelbarrow with the blade of the snowplow rotated upward, so that the blade will not interfere with the travel of the wheelbarrow.

FIG. 4 is a top view of the attachment apparatus that allows the snowplow blade to be attached to the wheelbarrow front brace.

FIG. 5 is a side view of the attachment apparatus.

### PREFERRED EMBODIMENT—DESCRIPTION

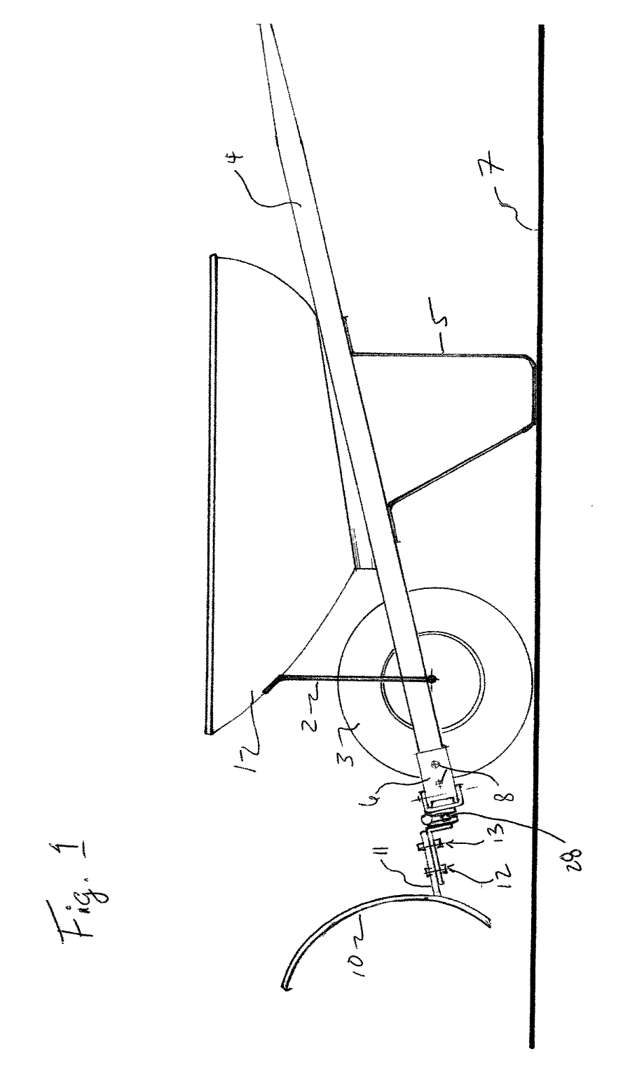

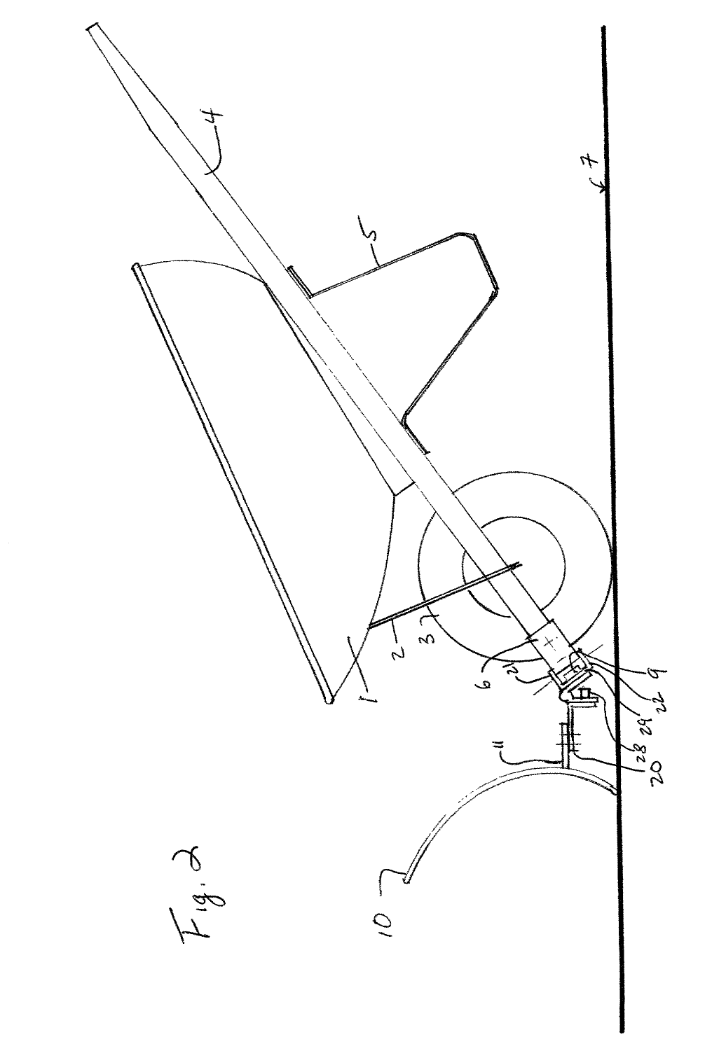

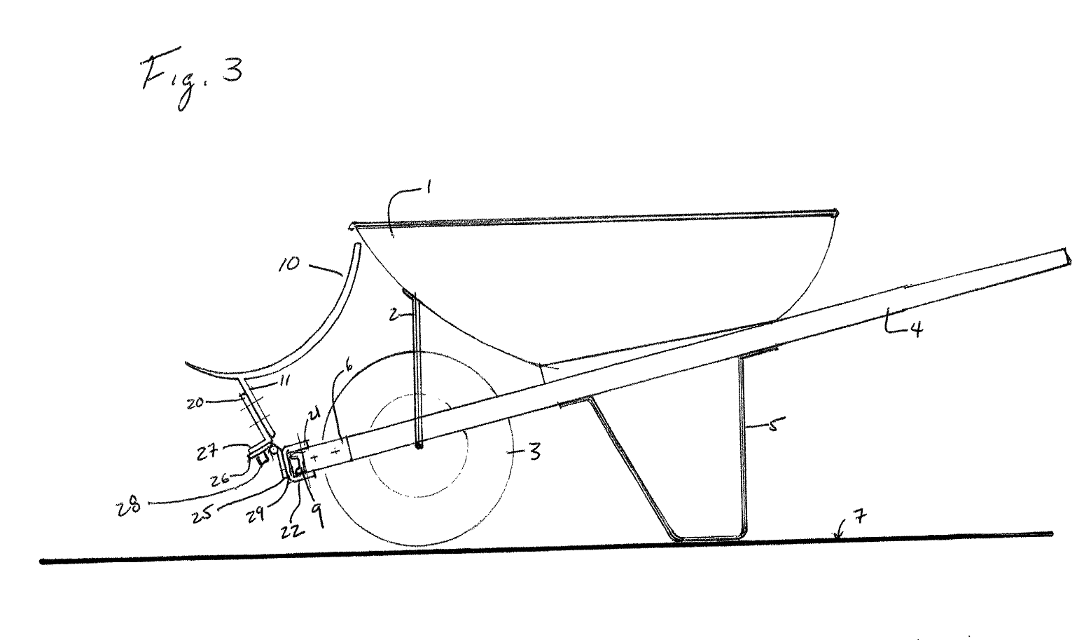

A typical embodiment of the current invention is illustrated in FIG. 1, FIG. 2, and FIG. 3. A preferred embodiment of the current invention is a snow removal device that is attached to a standard contractors type wheelbarrow. The wheelbarrow is typically comprised of a bucket 1, wooden arms 4 that support the bucket 1 and form most of the structure of the undercarriage of the wheelbarrow, braces 2, a large pneumatic tire 3, and legs 5 that support the wheelbarrow when not in use. The typical wheelbarrow also contains a front brace 6, which is attached to the two arms 4 by bolts 8. The most forward portion 9 of the front brace 6 may be constructed of a channel material 9 to add strength and to provide a contact point with the ground 7 when the wheelbarrow is dumped forward. The depth and the shape of the channel material 9 are somewhat variable. Moreover, the most forward portion 9 may be flat in lightweight wheelbarrows.

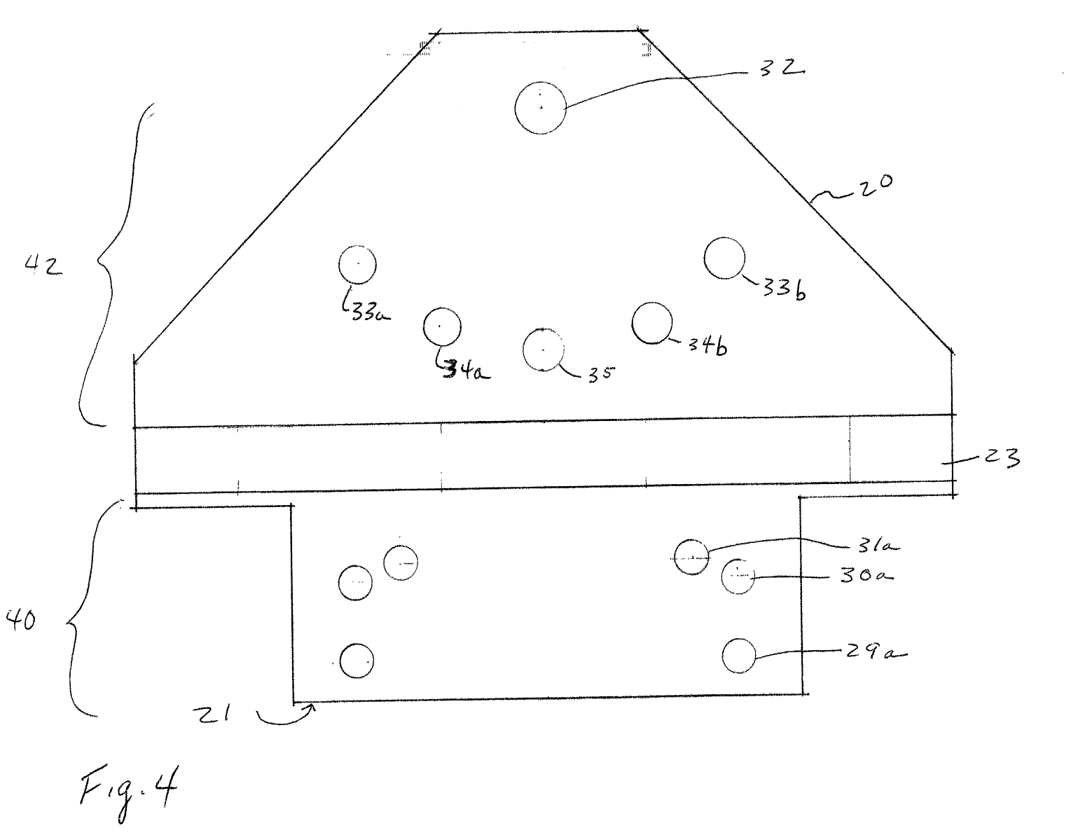

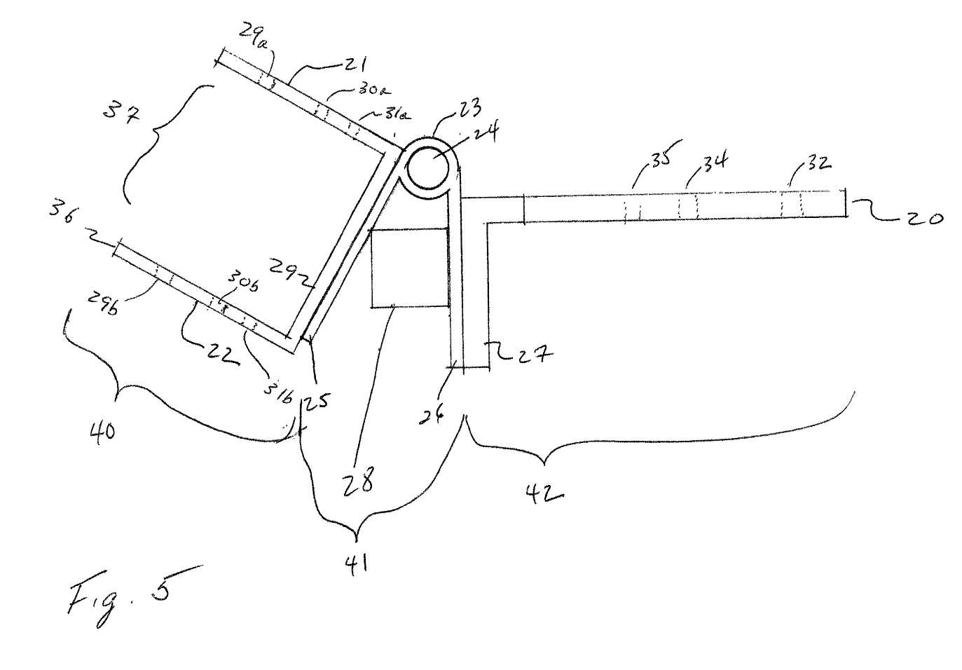

Also demonstrated (in FIG. 5) is the attachment apparatus, comprised of a posterior portion 40 that fits over and is releasably attached to the front brace 6, a hinged element 41 containing a spacer element 28, and an anterior element 42 which is releasably attached to the snowplow blade 10. FIGS. 4 and 5 demonstrate these elements to better advantage, but FIGS. 1, 2, and 3 demonstrate the relationship of the attachment apparatus to the wheelbarrow and the snowplow blade 10. In FIG. 5, one can see that the posterior portion 40 is comprised of “U” shaped metal piece with upper 21 and lower 22 members and a connecting anterior member 29. The space 37 between the upper 21 and lower 22 members receives the most forward portion 9 of the front brace 6 of the wheelbarrow in FIG. 2. The attachment apparatus is releasably attached to the most forward portion 9 of the brace 6 by placing pins or bolts (not shown) through holes 29a, 30a, and 31a in the upper member 21 and then through the corresponding holes 29b, 30b, and 31b in the lower member 22. The holes utilized will depend on the thickness or depth of the most forward portion 9 of the brace 6. An extensive field survey of commercially available wheelbarrows determined that three sets of holes would accommodate most wheelbarrows. Since it is necessary for the bolts (not shown) that fit through these holes to fit closely to the posterior aspect of the most forward portion 9 of the brace 6, a spacer (not shown) may be provided to insure that there is no motion between the attachment apparatus and the wheelbarrow.

Alternative embodiments (not shown) may provide for clamps, bolts, or other means of releasably affixing the attachment apparatus to the wheelbarrow. The preferred embodiment, however, is likely the simplest, cheapest, and easiest method.

Returning to FIGS. 4 and 5, the hinge mechanism 41 is comprised of anterior 26 and posterior 25 plates, and hinge pin or bolt 24, and a spacer element 28. The posterior hinge plate 25 is affixed to the anterior member 29 of the posterior portion 40 of the attachment apparatus, preferably by welding. The anterior hinge plate 26 is similarly affixed to an arm 27 of the anterior element 42. A spacer element 28 prevents the anterior 26 and posterior 25 hinge plates from approximating. Because of the angled orientation of the arms 4 of the wheelbarrow, the weight of the snowplow blade 10 will cause hinge plates (25, 26) to approximate if there were no spacer 28. This would cause the blade 10 to rest on the ground 7 when the wheelbarrow was parked, and raising the handles 4 of the wheelbarrow to utilize it would cause the blade 10 to more forcibly engage the ground, creating awkwardness with maneuverability. The spacer 28 of the current invention allows the wheelbarrow to be parked with the blade 10 not touching the ground 7, and also for the handles 4 of the wheelbarrow to be raised a few inches for travel without the blade 10 engaging the ground 7. This configuration creates ease of maneuverability. When the handles 4 of the wheelbarrow are raised to the normal operating position, i.e., the operator is standing erect with arms relatively straight and hands gripping the handles of the arms 4, the lower edge of the blade 10 engages the ground 7 or surface to be plowed 7. This allows the operator or homeowner to plow snow simply by walking forward and pushing the wheelbarrow. The position of the blade 10 relative to the ground 7 is ideal for plowing or pushing snow. If the operator encounters ice or wishes to scrape the surface 7, elevating the handles 4 of the wheelbarrow higher, as in FIG. 2, will cause the blade 10 of the snowplow to rotate so the lower edge of the blade 10 engages the ground 7 in a more acute angle. This angle is similar to that of a snow shovel, and allows the blade to dig under the snow or ice. The presence and the position of the hinge create the configuration that allows this flexibility in use of the device.

FIG. 3 illustrates another advantage of the hinged attachment apparatus in that it allows the blade 10 to be rotated upward and secured to the bucket 1 of the wheelbarrow. This configuration would allow free travel and use of the wheelbarrow as if the plow blade were not attached. Securing means (not shown) may include a latch, chain, grommet, rope, or any easily secured and releasable means and may be attached to the bucket 1, brace 2, or other elements of the wheelbarrow. A preferred securing means (not shown) is a simple cam cleating mechanism affixed to the lip of the bucket 1 or to the brace 2. A line or rope, attached to the blade 10, traverses the cam cleating mechanism and continues to the rear of the wheelbarrow in easy reach of the operator. This allows the operator to raise or lower the blade 10 to any height chosen without the operator having to continuously hold onto the line or to walk to the front of the wheelbarrow to raise or lower the blade 10.

FIGS. 4 and 5 also illustrate the anterior element 42 of the attachment apparatus. The anterior element 42 is an “L” shaped metal member tapered toward its front edge. This allows the blade 10 to be angled to either side. The upper plate 20 contains a hole 32 for securing the attachment apparatus to a posterior element 11 of the blade 10, preferably by a bolt 12 (as shown in FIG. 1.) Other holes 33, 34, 35 receive a bolt or pin 13 which also traverses the posterior element 11 of the blade 10 so as to orient the blade 10 in a straight or angled configuration. As shown in FIG. 4, the five holes 33a, b, 35a, b, and 35 in the posterior aspect of the anterior element 42 allow the blade 10 to be positioned straight (orthogonal to the axis of travel), or angled to the left or right either 25 or 55 degrees. The 25-degree angulation is best utilized when clearing light snow, and the 55-degree angulation is best used when clearing heavy, deep, or wet snow or anytime lesser resistance is desired. However, multiple different configurations are possible.

Wheelbarrows have variable sizes of tires 3, variation in the angulations of the arms 4, variation in the height of operator, and variation in the height of the brace 6. This creates a situation in which the blade 10 may not be optimally placed in relationship to the ground 7 with the wheelbarrow at rest or in a functional position. If the blade were placed too high, the handles would need to be raised further than the usual comfortable position to place the blade on the ground, creating strain on the operator. Similarly, if the blade were too low, it would be awkward to maneuver the wheelbarrow. To accommodate this variability, the posterior element 11 of the blade 10 may be placed above or below the upper plate 20 of the anterior element 42. To elevate or lower the blade 10 even further, washers or other elements (not shown) may be used as spacers and placed between the upper plate 20 of the anterior element 42 and the posterior element 11 of the blade 10. This allows quick and easy adjustments of height of the blade without resorting to adjustable brackets on the blade 10, the attachment apparatus, or the wheelbarrow. An alternative embodiment may in fact utilize adjustable brackets (not shown) to accommodate the variability in height, but the preferred embodiment is much simpler.

The blade 10 of the invention may take any one of several configurations and sizes. Preferred embodiments include blade length of 24-48 inches and blade height of 8-18 inches, although other dimensions are feasible. Fourteen to 18 gauge steel is preferred, as no supporting structure is needed. The posterior element 11 is simply welded to the blade 10. The angle at which the posterior element is welded, however, affects the functionality of the blade and the device as a whole. In the case of angling the blade to the right 55 degrees, the left and forward edge of the blade 10 will contact the ground well before the right and trailing edge of the blade 10 if the posterior element 11 is welded horizontally to the blade 10. This is a result of the axle of the wheel of the wheelbarrow being the axis of rotation, the left or forward edge projecting a significant distance away from the axis, while the right or trailing edge is much closer to the axis of rotation. This creates a need to angle the wheelbarrow on the wheel in an oblique sagittal plane with the left handle above the right handle. This is awkward and uncomfortable for the operator. To solve this dilemma, the posterior element 11 is welded to the blade 10 at an angle to horizontal so that when the blade is straight or orthogonal to the direction of travel, the left edge is 1-2 inches above the right edge. This creates some angling of the wheelbarrow when plowing with the blade straight, but dramatically lessens the steep angle needed when plowing with the blade angled 55 degrees to the right. This solution obviously aggravates the situation if the blade is angled to the left, necessitating that most plowing be done to the right.

This dilemma is partially solved by the position of hinge 23 of the attachment apparatus, which allows the blade to rotate so that the lower edge of the blade 10 does indeed engage the ground 7 along its entire length. This is accomplished simply by raising the handles 4 of the wheelbarrow slightly. The angling of the wheelbarrow, to keep the blade 10 fully engaged, can be overcome by the operator raising the handles 4. This minor operational adjustment is preferable to other more costly solutions, such as providing an alternative embodiment that is comprised of a rotatably adjustable bracket (not shown) to solve this problem. Thus, the presence and position of the hinged mechanism 41 creates several different advantages in functionality and solves other problems associated with using a wheelbarrow for snow removal.

The operator simply walks forward in a manner similar to pushing a wheelbarrow without a snowplow blade attached. The size of the wheelbarrow, the large pneumatic tire, and the leverage add to the efficiency. If the snow is deep or heavy, ballast may be easily added to the bucket 1 of the wheelbarrow to add more mass. The additional mass creates more momentum, allowing the operator to continue walking forward and plowing snow without repeatedly being stopped by the weight of the snow. By angling the blade to one side, snow will be diverted to one side of a sidewalk in one direction. When the operator returns, in the other direction, the snow will be diverted to the opposite side of the sidewalk. This allows the homeowner to clear the sidewalk by simply pushing the wheelbarrow-snowplow apparatus to an appropriate point on the sidewalk or sidewalks, and returning to the starting point, pushing the wheelbarrow and plowing the snow. Other manual snow pusher devices or lightweight snowplows do not provide for adding ballast to overcome the weight of the snow.

### CONCLUSIONS, RAMIFICATIONS, AND SCOPE

Although the description above contains many specificities, these should not be construed as limiting the scope of the invention but as merely providing illustrations of some of the presently preferred embodiments of this invention. Various other embodiments and ramifications are possible within its scope. For example, an alternative embodiment may include a “V” shaped snowplow blade instead of the straight moldboard of the preferred embodiment. This would create advantages and disadvantages over the preferred embodiment. The “V” shaped blade may provide less resistance when plowing snow on a sidewalk, making it easier for the homeowner to operate, but would not be as effective in clearing parking areas. Another alternative to solve this dilemma would be a blade that converts from a “V” shape to a more or less straight moldboard. While solving many of the disadvantages of the “V” or straight moldboard, it would be more complex and more expensive to manufacture. While these embodiments are not described in detail in this specification, it is the intent that they also be covered by the scope of this patent.

Thus, the scope of the invention should be determined by the appended claims and their legal equivalents.

What is claimed is:

1. A snowplow apparatus adapted to be attached to a wheelbarrow or wheeled lawn cart, comprising:
a. a blade assembly having a front face for effecting displacement of snow accumulated on the ground surface over which said blade assembly is caused to traverse, and a second back face having a blade support operatively attached thereto;
b. an attachment apparatus having a first and second end, said first end operatively associated with said blade support and said second end operatively associated with said wheelbarrow or said wheeled lawn cart.

2. The device set forth in claim 1, wherein said attachment apparatus further comprises a hinged element which provides for rotation of the snowplow blade in respect to the wheelbarrow.

3. The device set forth in claim 1, wherein said attachment apparatus further comprises a spacer element placed between the leaves of said hinged element which prevents said blade from contacting the ground when the said wheelbarrow is parked.

4. The device set forth in claim 1, further comprising a second attachment element attached having a first and second end, said first end operatively associated with said blade and said second end operatively associated with said wheelbarrow or wheeled lawn cart to facilitate pivotable movement of said blade, which effects rotation of the said blade when traction is applied to said second end of said second attachment element.

5. The device as set forth in claim 1, further comprising means for lateral rotation of said blade with respect to said wheelbarrow.

6. The device as set forth in claim 1, wherein said attachment element and said blade support element provide for fixed angular orientation of said blade.

7. The device as set forth in claim 1, wherein said attachment element is operatively associated with the front brace of said wheelbarrow.

8. The device as set forth in claim 1, wherein said attachment element further comprises means for modifying the distance of said blade from the ground.

9. The device as set forth in claim 1, further containing means for attachment to wheeled instruments normally used for purposes other than clearing snow.

10. The device as set forth in claim 1, wherein said attachment element is adaptable to different makes and sizes of said wheelbarrows or said wheeled lawn carts.

11. A method of plowing snow, comprising:
a. providing a snowplow blade;
b. providing a connecting mechanism associated with said blade capable of attaching to a wheelbarrow or wheeled lawn cart;
c. moving said wheelbarrow or lawn cart in a forward direction, thereby moving said snowplow blade in a forward ground contacting orientation.

12. The method as set forth in claim 11, wherein the said blade is raised from the ground by lowering the handles of said wheelbarrow.

13. The method as set forth in claim 11, further providing an element connected to said blade whereby traction on said connecting element causes said blade to raise from the ground.

14. The method as set forth in claim 11, wherein a desired amount of ballast is placed within said wheelbarrow or said wheeled lawn cart.
